(19) United States
(12) Patent Application Publication
(10) Pub. No.: US 2025/0184056 A1
(43) Pub. Date: Jun. 5, 2025

(54) METHOD AND APPARATUS FOR ENCODING AND DECODING POLAR CODES IN WIRELESS COMMUNICATION SYSTEM

(71) Applicant: Electronics and Telecommunications Research Institute, Daejeon (KR)

(72) Inventors: Jung-Im KIM, Daejeon (KR); Young Jo KO, Daejeon (KR); Il Gyu KIM, Daejeon (KR); Sung Cheol CHANG, Daejeon (KR); Hee Sang CHUNG, Daejeon (KR); Yong Seouk CHOI, Daejeon (KR)

(21) Appl. No.: 18/970,789

(22) Filed: Dec. 5, 2024

(30) Foreign Application Priority Data
Dec. 5, 2023 (KR) 10-2023-0174908

(51) Int. Cl. H04L 5/00; H04L 1/00

(52) U.S. Cl. CPC H04L 5/0035; H04L 1/0061; H04L 5/0053

(57) ABSTRACT

A method of a user equipment (UE) may comprise: receiving, from a base station, a first message including information of TRP sets each composed of TRPs and input data mapping information; receiving, from the base station, a second message including information on a first TRP set to be used for communication among the TRP sets and information on an order of TRPs included in the first TRP set; receiving signals from the TRPs included in the first TRP set; and decoding each of the signals received from the TRPs included in the first TRP set using a polar decoder based on the input data mapping information.

### CROSS-REFERENCE TO RELATED APPLICATIONS

This application claims priority to Korean Patent Application No. 10-2023-0174908, filed on Dec. 5, 2023, with the Korean Intellectual Property Office (KIPO), the entire contents of which are hereby incorporated by reference.

### BACKGROUND

### 1. Technical Field

The present disclosure relates to a technique for encoding and decoding in a wireless communication system, and more particularly, to a technique for encoding and decoding polar codes.

### 2. Related Art

In 3^{rd} generation partnership project (3GPP) Release 15 and Release 16, three scenarios for 5G New Radio (NR) have been introduced. These three scenarios may include enhanced Mobile Broadband (eMBB), massive Machine Type Communication (mMTC), and ultra-reliable low latency communication (URLLC). Regarding these technologies, 3GPP Release 17 and Release 18 have conducted standardization efforts for 5G-Advanced technologies.

Additionally, 3GPP NR classifies the frequency domain into Frequency Range 1 (FR1) and Frequency Range 2 (FR2) for standardization efforts. FR2 operates at a higher frequency than FR1, resulting in a more challenging wireless channel environment with lower cell-edge throughput and reliability. Specifically, in an FR1 wireless channel environment, when electromagnetic waves encounter obstacles, they may propagate through diffraction, leading to multi-path propagation. However, in a high-frequency FR2 wireless channel environment, diffraction effects are reduced, increasing the likelihood that electromagnetic waves will be blocked by obstacles rather than creating multi-path propagation. Additionally, propagation loss increases, leading to a reduction in the communication range between the transmitter and receiver.

In such high-frequency wireless channel environments, multi-transmission and reception point (TRP) transmission is increasingly required to reduce the probability of link failure due to signal blockage and compensate for propagation loss.

### SUMMARY

The present disclosure for resolving the above-described problems is directed to providing a method and an apparatus of encoding and decoding polar codes for enhancing communication reliability by increasing a channel coding gain in a wireless communication system using multiple TRPs.

A method of a user equipment (UE), according to an exemplary embodiment of the present disclosure for achieving the above-described objective, may comprise: receiving, from a base station, a first message including information of transmission and reception point (TRP) sets each composed of TRPs and input data mapping information; receiving, from the base station, a second message including information on a first TRP set to be used for communication among the TRP sets and information on an order of TRPs included in the first TRP set; receiving signals from the TRPs included in the first TRP set; and decoding each of the signals received from the TRPs included in the first TRP set using a polar decoder based on the input data mapping information.

The method may further comprise: determining whether decoding is successful or not using cyclic redundancy check (CRC) bits for decoded symbols; in response to determining that decoding of all signals received from the TRPs included in the first TRP set fails, combining information bits corresponding to each other among outputs of polar decoders of different TRPs, based on the input data mapping information; determining information bits using the combined information bits; determining whether decoding of the determined information bits is successful or not using the CRC bits; and transmitting a decoding result report message to the base station.

The information bits corresponding to each other may be combined using either a soft combining scheme or a maximum ratio combining scheme.

The input data mapping information may indicate positions of frozen bits and input positions of information bits for a polar encoder of each of the TRPs included in the first TRP set.

The positions of the frozen bits may be determined based on mutual information values.

The positions of the frozen bits may be identical for all polar encoders included in the first TRP set.

The TRPs included in the first TRP set may transmit same information bits, and input positions of information bits may be different for polar encoders corresponding to the TRPs included in the first TRP set.

A method of a base station, according to an exemplary embodiment of the present disclosure, may comprise: transmitting, to a user equipment (UE), a first message including information of transmission and reception point (TRP) sets each composed of TRPs and input data mapping information; transmitting, to the UE, a second message including information on a first TRP set to be used for communication among the TRP sets and information on an order of TRPs included in the first TRP set; instructing each of the TRPs included in the first TRP set to encode data based on the input data mapping information; and transmitting the encoded data to the UE via the TRPs included in the first TRP set.

The input data mapping information may indicate positions of frozen bits and input positions of information bits for a polar encoder of each of the TRPs included in the first TRP set.

The positions of the frozen bits may be determined based on mutual information values.

Input positions of information bits may be different for polar encoders corresponding to the TRPs included in the first TRP set.

When the first TRP set includes two TRPs, input positions of the information bits for the two TRPs may be determined such that: the information bits are arranged at positions excluding the positions of the frozen bits among input ports of a first polar encoder of a first TRP, in order from a position with a smallest mutual information value to a position with a highest mutual information value, and the information bits are arranged at positions excluding the positions of the frozen bits among input ports of a second polar encoder of a second TRP, in order from the position with the highest mutual information value to the position with the smallest mutual information value.

When the first TRP set includes four TRPs, input positions of the information bits for the four TRPs may be determined such that: the information bits are arranged at positions excluding the positions of the frozen bits among input ports of a first polar encoder of a first TRP in order from a position with a smallest mutual information value to a position with a highest mutual information value; the information bits are arranged at positions excluding the positions of the frozen bits among input ports of a second polar encoder of a second TRP in order from the position with the highest mutual information value to the position with the smallest mutual information value; the information bits are arranged at positions excluding the positions of the frozen bits among input ports of a third polar encoder of a third TRP by circularly shifting the information bits of the first polar encoder by [K/2]; and the information bits are arranged at positions excluding the positions of the frozen bits among input ports of a fourth polar encoder of a fourth TRP by circularly shifting the information bits of the second polar encoder by [K/2].

Data transmitted by the TRPs included in the first TRP set to the UE may be same data.

A user equipment (UE), according to an exemplary embodiment of the present disclosure for achieving the above-described objective, may comprise at least one processor, wherein the at least one processor causes the UE to perform: receiving, from a base station, a first message including information of transmission and reception point (TRP) sets each composed of TRPs and input data mapping information; receiving, from the base station, a second message including information on a first TRP set to be used for communication among the TRP sets and information on an order of TRPs included in the first TRP set; receiving signals from the TRPs included in the first TRP set; and decoding each of the signals received from the TRPs included in the first TRP set using a polar decoder based on the input data mapping information.

The at least one processor may further cause the UE to perform: determining whether decoding is successful or not using cyclic redundancy check (CRC) bits for decoded symbols; in response to determining that decoding of all signals received from the TRPs included in the first TRP set fails, combining information bits corresponding to each other among outputs of polar decoders of different TRPs, based on the input data mapping information; determining information bits using the combined information bits; determining whether decoding of the determined information bits is successful or not using the CRC bits; and transmitting a decoding result report message to the base station.

The information bits corresponding to each other may be combined using either a soft combining scheme or a maximum ratio combining scheme.

The input data mapping information may indicate positions of frozen bits and input positions of information bits for a polar encoder of each of the TRPs included in the first TRP set.

The positions of the frozen bits may be determined based on mutual information values.

The TRPs included in the first TRP set may transmit same information bits, and input positions of information bits may be different for polar encoders corresponding to the TRPs included in the first TRP set.

According to exemplary embodiments of the present disclosure, when the same data is transmitted to a UE via multiple TRPs, changing the order of bits input to a polar encoder in each TRP allows the UE receiving signals from the TRPs to achieve not only diversity gain but also an increase in channel coding gain. Furthermore, if decoding failure occurs for the data received from all multiple TRPs, the UE may re-estimate information bits through LLR combining and perform a CRC check on the re-estimated information bits, thereby achieving an improvement in decoding performance.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram illustrating a case where each of two TRPs transmits a PDCCH and a PDSCH to a single user equipment (UE).

FIG. 3B is a conceptual diagram illustrating a case where two TRPs transmit PDCCHs to a single UE in an SFN scheme.

FIG. 3C is a conceptual diagram illustrating a case where two TRPs transmit PDCCHs to a single UE in a non-SFN scheme.

FIG. 4A is a conceptual diagram illustrating input and output of a polar encoder.

FIG. 4B is a conceptional diagram illustrating an internal structure of a polar encoder.

FIG. 5 is a conceptual diagram illustrating input and output of a polar decoder.

FIG. 6 is a conceptual diagram illustrating a case where each of two TRPs transmits information to a single UE using a polar encoder.

FIG. 7 is a conceptual diagram illustrating a decoding operation of a polar decoder in a UE receiving information from two TRPs.

FIG. 8 is a sequence chart illustrating a case where a base station transmits data to a ULE using polar encoders in multiple TRPs.

FIG. 9 is a flowchart illustrating a process in which a UE decodes signals received from multiple TRPs using polar decoders.

FIG. 10 is a simulation graph comparing performance of the present disclosure and conventional techniques in an AWGN channel.

FIG. 11 is a simulation graph comparing performance of the present disclosure and conventional techniques in a Rayleigh channel.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

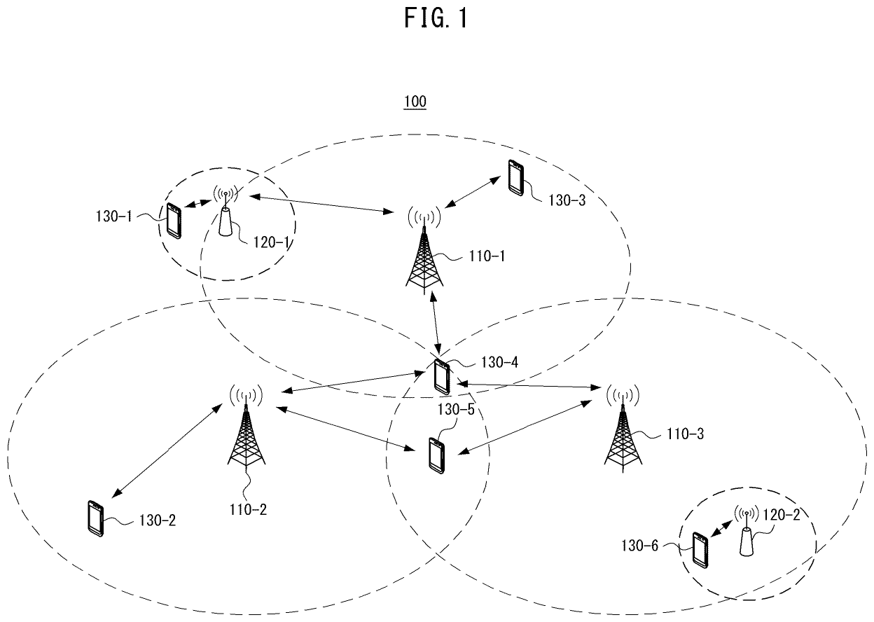

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

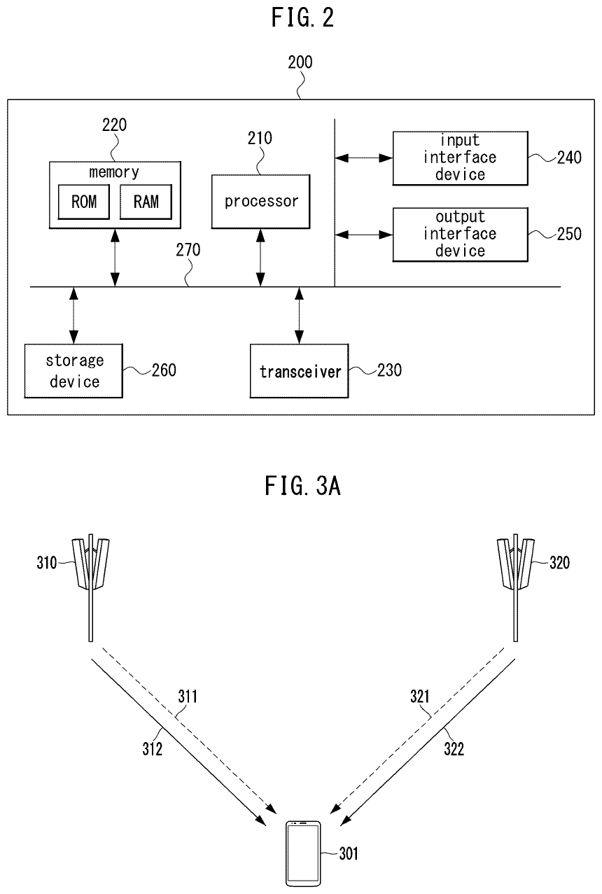

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, the 3GPP RAN1 is conducting technical standardization work on a physical layer for multiple TRPs (multi-TRP) to support non-coherent joint transmission (NCJT) from a base station or base station panels. The NCJT may be a technology that can achieve MIMO gain without strict synchronization and mutual phase coherence requirements for multi-TRP cooperation points. The NCJT may be performed in situations where all transmission antennas within a multi-TRP cooperation set cannot be combined into a single distributed array.

In 3GPP Release 16 and 3GPP Release 17, the standardization work for multi-TRP aims to improve cell-edge throughput, reliability, and robustness.

In 3GPP Release 16, a standardization work for multi-TRP has focused only on physical downlink shared channel (PDSCH), which transmits downlink data. In 3GPP Release 17, a standardization work for multi-TRP has been extended to physical downlink control channel (PDCCH), which transmits downlink control information, physical uplink shared channel (PUSCH), which transmits uplink data, and physical uplink control channel (PUCCH), which transmits uplink control information.

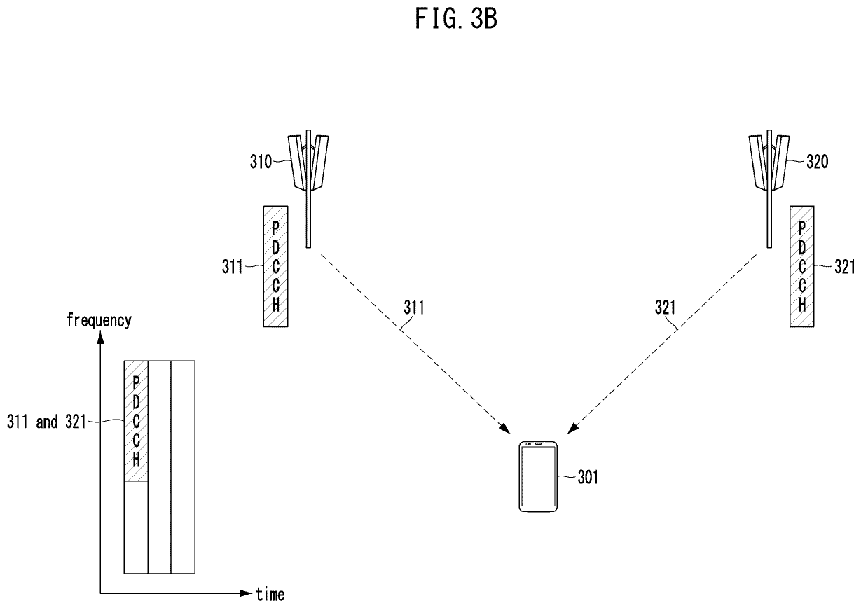

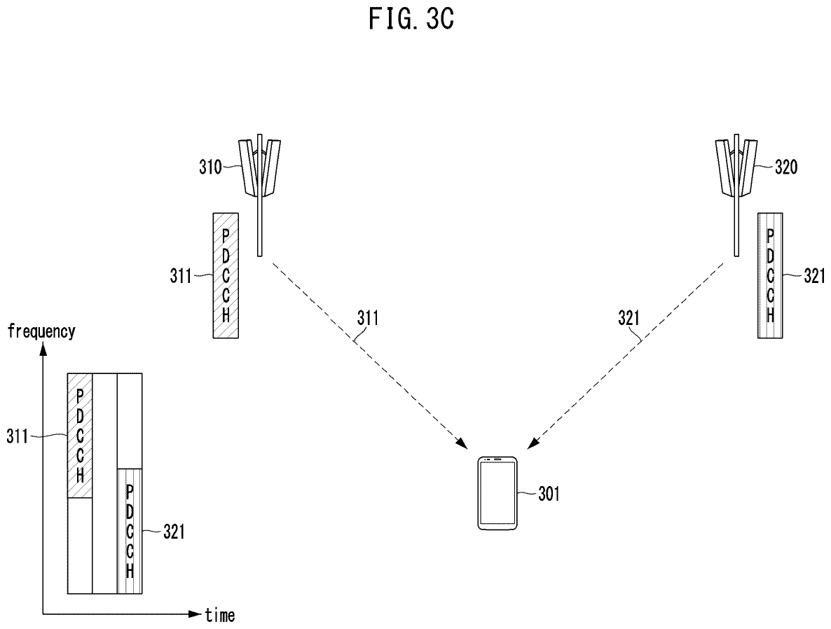

FIG. 3A is a conceptual diagram illustrating a case where each of two TRPs transmits a PDCCH and a PDSCH to a single user equipment (UE).

Referring to FIG. 3A, a first TRP 310 and a second TRP 320 are illustrating as transmitting data to a UE 301. Here, the first TRP 310 and the second TRP 320 may be understood as different panels.

Describing the data transmission in FIG. 3A in more detail, the first TRP 310 may transmit a first PDCCH 311 to the UE 301, and transmit a first PDSCH 312 based on the first PDCCH 311. Here, the first PDCCH 311 may include downlink control information (DCI) for scheduling the first PDSCH 312. Additionally, the second TRP 320 may transmit a second PDCCH 321 to the UE 301, and transmit a second PDSCH 322 based on the second PDCCH 321. Here, the second PDCCH 321 may include DCI for scheduling the second PDSCH 322.

Each DCI of the first PDCCH 311 and the second PDCCH 321 may include various control information, such as resource allocation information, modulation and coding scheme (MCS), and redundancy version (RV).

Meanwhile, in 3GPP Release 17, PDCCH enhancements have been discussed. The PDCCH enhancements discussed in 3GPP Release 17 are related to multi-TRP transmission schemes in FR2 bands, which use millimeter waves (mmWave). Specifically, in 3GPP Release 17, PDCCH enhancements targeting high-speed trains have been discussed, and PDCCH enhancements also have been discussed for both single frequency network (SFN) and non-single frequency network (non-SFN) schemes.

FIG. 3B is a conceptual diagram illustrating a case where two TRPs transmit PDCCHs to a single UE in an SFN scheme.

Referring to FIG. 3B, the first TRP 310 may transmit the first PDCCH 311 to the UE 301, and the second TRP 320 may transmit the second PDCCH 321 to the UE 301. The first TRP 310 and the second TRP 320 may be understood as different panels. Comparing FIG. 3B with FIG. 3A, FIG. 3B differs in that it does not illustrate transmission of PDSCHs, which are illustrated in FIG. 3A.

In FIG. 3B, a dashed arrow from the first TRP 310 to the UE 301 represents a wireless channel through which the first PDCCH 311 is transmitted. Additionally, the first PDCCH 311, represented by a box to the left of the first TRP 310, illustratively visualizes mapping of DCI onto frequency and time resources for transmission. Similarly, in FIG. 3B, a dashed arrow from the second TRP 320 to the UE 301 represents a wireless channel through which the second PDCCH 321 is transmitted. Additionally, the second PDCCH 321, represented by a box to the right of the second TRP 320, illustratively visualizes mapping of DCI onto frequency and time resources for transmission.

In the SFN-based PDCCH enhancement scheme discussed in 3GPP Release 17, different TRPs/panels may each transmit PDCCHs to a UE, and the PDCCHs transmitted by different TRPs/panels to the UE may be configured to use the same time and frequency resources. Additionally, the PDCCHs transmitted by different TRPs/panels may contain the same duplicated data.

Referring to time-frequency resources in a lower-left part of FIG. 3B, the first PDCCH 311 transmitted by the first TRP 310 to the UE 301 and the second PDCCH 321 transmitted by the second TRP 320 to the UE 301 may be transmitted using the same time and frequency resources. Therefore, the UE 301 may receive the first PDCCH 311 transmitted by the first TRP 310 and the second PDCCH 321 transmitted by the TRP 320 using the same time and frequency resources.

As illustrated in FIG. 3B, the UE 301 may receive the PDCCHs 311 and 321 from different TRPs 310 and 320 through the same time and frequency resources. In this case, the UE 301 may be provided with transmission configuration indication (TCI) states in advance to receive the PDCCHs 311 and 321 from the TRPs 310 and 320 through specific beams. Each of the TCI states provided by the first TRP 310 and the second TRP 320 to the UE 301 may include reception configuration indication for simultaneously receiving the PDCCHs from the first TRP 310 and second TRP 320.

The SFN scheme illustrated in FIG. 3B requires the UE 301 to receive the PDCCHs from the first TRP 310 and second TRP 320 using the same resources, namely, the same time and frequency resources. Therefore, strict synchronization between the first TRP 310 and second TRP 320 may be required.

FIG. 3C is a conceptual diagram illustrating a case where two TRPs transmit PDCCHs to a single UE in a non-SFN scheme.

Referring to FIG. 3C, the first TRP 310 may transmit the first PDCCH 311 to the UE 301, and the second TRP 320 may transmit the second PDCCH 321 to the UE 301. The first TRP 310 and second TRP 320 may be understood as different panels. Comparing FIG. 3C with FIG. 3A, FIG. 3C differs in that it does not illustrate transmission of PDSCHs illustrated in FIG. 3A.

In FIG. 3C, a dashed arrow from the first TRP 310 to the UE 301 represents a wireless channel through which the first PDCCH 311 is transmitted. Additionally, the first PDCCH 311, represented by a box to the left of the first TRP 310, illustratively visualizes mapping of DCI to frequency and time resources for transmission. Similarly, in FIG. 3C, a dashed arrow from the second TRP 320 to the UE 301 represents a wireless channel through which the second PDCCH 321 is transmitted. Additionally, the second PDCCH 321, represented by a box to the right of the second TRP 320, illustratively visualizes mapping of DCI to frequency and time resources for transmission.

FIG. 3C illustrates a non-SFN scheme, where a PDCCH transmitted by one TRP and a PDCCH transmitted by another TRP may be multiplexed within resources of candidate sets. More specifically, as illustrated in a lower-left part of FIG. 3C, the first PDCCH 311 and the second PDCCH 321 may be multiplexed within a candidate set comprising time and frequency resources. For example, as illustrated in FIG. 3C, the first PDCCH 311 may be allocated to the first OFDM symbol among three OFDM symbols, and the second PDCCH 321 may be allocated to the third OFDM symbol among the three OFDM symbols. Additionally, as illustrated in FIG. 3C, frequency resources allocated to the first PDCCH 311 and the second PDCCH 321 may also be different. Using the method illustrated in FIG. 3C, the first PDCCH 311 and the second PDCCH 321 may be multiplexed.

In the non-SFN scheme described above, as described and illustrated in FIG. 3C, the first PDCCH 311 and the second PDCCH 321 are transmitted in a multiplexed manner. Therefore, the 3GPP technical specifications do not support a scheme in which the repetition count of each PDCCH dynamically changes.

Hereinafter, a channel coding scheme for overcoming errors in a wireless channel will be described.

According to the 3GPP 5G NR technical specifications, low-density parity-check (LDPC) codes have been specified for use in both downlink data channel (i.e. PDSCH) and uplink data channel (i.e. PUSCH). Additionally, polar codes have been specified for use in both downlink control channel (i.e. PDCCH) and physical broadcast channel (i.e. PBCH).

When the length of input data to be encoded is less than 1000 bits, polar codes exhibit superior performance compared to LDPC codes and turbo codes. Therefore, 3GPP has adopted polar codes as a standard technology for short-length control channels and broadcast channels in the 5G NR system. The maximum payload length of a 5G NR downlink control channel is 140 bits, the length of a PBCH is 56 bits, and the maximum payload length of a 5G NR uplink control channel is 1706 bits. Here, information bits of PBCH may be 32 bits, and cyclic redundancy check (CRC) bits therefor may be 24 bits.

Meanwhile, in 3GPP LTE, standardization of narrowband Internet of Things (NB-IoT) services has been completed. A characteristic of NB-IoT is that the length of transmitted data is not long. Another characteristic of NB-IoT is that the reception performance of data is highly sensitive to the power of the terminal. In the NB-IoT system, the base station may encode data for transmission using a tail-biting convolutional code (TBCC), and the terminal may encode data for transmission using a turbo code.

As described above, when the length of data to be transmitted in a mobile communication system is short, using a polar code for encoding transmission data may be more efficient in terms of channel coding gain than using an LDPC code.

Additionally, the 3GPP physical layer may add CRC bits to channel-coded transmission symbols to allow a receiving node to efficiently verify successful decoding. The reliability of CRC may vary depending on the CRC bit length. When the CRC bit length is denoted as L, the reliability of CRC bits may be calculated as shown in Equation 1.

$$reliablity of CRC bits = 1 - {2}^{- L} \qquad [ Equation 1 ]$$

Hereinafter, a polar encoder will be described.

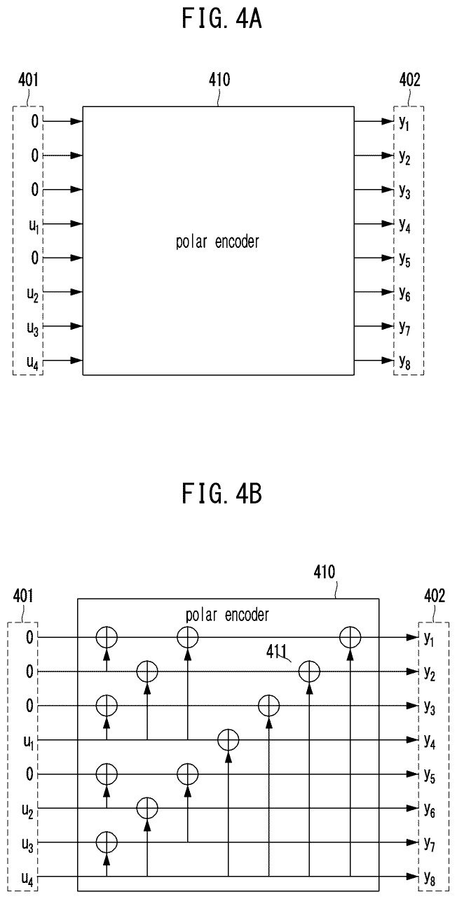

FIG. 4A is a conceptual diagram illustrating input and output of a polar encoder, and FIG. 4B is a conceptional diagram illustrating an internal structure of a polar encoder.

Referring to FIG. 4A, a polar encoder 410 with an 8-bit input is illustrated as an exemplary embodiment. The polar encoder 410 may encode input data 401 into a polar code and may output encoded symbols 402. Here, the input data 401 input to the polar encoder 410 may be information bits. Additionally, the encoded symbols 402 encoded by the polar encoder 410 may be output bits.

First, the characteristics of the polar encoder 410 will be described. The polar encoder 410 may be an encoder that applies a channel polarization phenomenon of a polar code to achieve channel coding gain. The channel polarization phenomenon may refer to a phenomenon in which error characteristics of a wireless channel are determined according to a position of input bit input to the encoder. This will be described in more detail below.

For example, the input data 401 input to the polar encoder 410 may be encoded by the polar encoder 410 and then transmitted through a wireless channel to a receiving node. The receiving node may receive the encoded information through the wireless channel and may decode the received information using a decoder with an error correction scheme. In this case, an input bit at a specific position input to the polar encoder 410 may have a very low probability of overcoming errors even when decoding is performed at the receiving node. Conversely, an input bit at another specific position input to the polar encoder 410 may have a very high probability of overcoming errors when decoding is performed at the receiving node. This may be due to multiple recursive concatenations of the polar encoder 410. As the number of recursive concatenations increases, an input bit at a specific position input to the polar encoder 410 may experience either an increase or a decrease in channel reliability. This characteristic, in which the probability of overcoming errors at the receiving node is determined according to a position of an input bit input to the polar encoder 410, is referred to as channel polarization.

The magnitude of channel polarization may be expressed as a mutual information value, which is referred to as an information gain. An input bit transmitted at a bit position with very low mutual information may experience a channel with low reliability, whereas an input bit transmitted at a bit position with high mutual information may experience a channel with high reliability. Therefore, frozen bits may be mapped to positions experiencing the channel with low reliability among the input bit positions of the polar encoder 410, and information bits may be mapped to positions experiencing the channel with high reliability among the input bit positions of the polar encoder 410. Here, the frozen bits may be values known between the transmitting node and the receiving node.

FIG. 4A illustrates an example in which the polar encoder 410 with an 8-bit input outputs 8-bit encoded symbols 402. The indexes of input ports of the polar encoder 410 may be assumed to be assigned from top to bottom as an input port index 1, input port index 2, input port index 3, . . . , input port index 8. The indexes of output ports of the polar encoder 410 may also be assumed to be assigned in the same manner from top to bottom as an output port index 1, output port index 2, output port index 3, . . . , output port index 8.

In the example of FIG. 4A, input data 401 may be input to the input ports of the polar encoder 410. Additionally, in the example of FIG. 4A, a case where the frozen bits are set to zero (0) is illustrated. Under the above assumptions, the frozen bits and information bits input to the polar encoder 410 may be input as follows.

At the input ports with the indexes 1, 2, and 3, frozen bits ‘0’ may be input. At the input port with the index 4, information bit u₁ may be input. At the input port with the index 5, a frozen bit ‘0’ may be input again. At the input ports with the indexes 6, 7, and 8, information bits u₂, u₃, and u₄ may be input.

Under the above assumptions, the encoded symbols 402 output through polar encoding by the polar encoder 410 may be y₁, y₂, y₃, y₄, y₅, y₆, y₇, and y₈, respectively. Here, y₁, y₂, y₃, y₄, y₅, y₆, y₇, and y₈ may be output through output ports with indexes 1 to 8, respectively.

As shown in FIG. 4A, among 8 input ports of the polar encoder 410, frozen bits may be input to 4 input ports, and information bits may be input to the remaining 4 input ports. The polar encoder 410 may output 8 encoded symbols (or output bits). Accordingly, a coding rate of the polar encoder 410 illustrated in FIG. 4A may be 1/2.

Referring to FIG. 4B, an internal configuration of the polar encoder 410 is further illustrated. As shown in FIG. 4B, input data 401 may be concatenated in a multiple recursive form using exclusive OR (XOR) operators 411. Each of the encoded symbols 402 in FIG. 4B may be obtained by performing XOR operations 411 with the input data 401, as expressed in Equation 2 below.

$${y}_{1} = {u}_{1} ⊕ {u}_{2} ⊕ {u}_{3} ⊕ {u}_{4} \qquad [ Equation 2 ]$$

$${y}_{2} = {u}_{1} ⊕ {u}_{2} ⊕ {u}_{4}$$

$${y}_{3} = {u}_{1} ⊕ {u}_{3} ⊕ {u}_{4}$$

$${y}_{4} = {u}_{1} ⊕ {u}_{4}$$

$${y}_{5} = {u}_{2} ⊕ {u}_{3} ⊕ {u}_{4}$$

$${y}_{6} = {u}_{2} ⊕ {u}_{4}$$

$${y}_{7} = {u}_{3} ⊕ {u}_{4}$$

$${y}_{8} = {u}_{4}$$

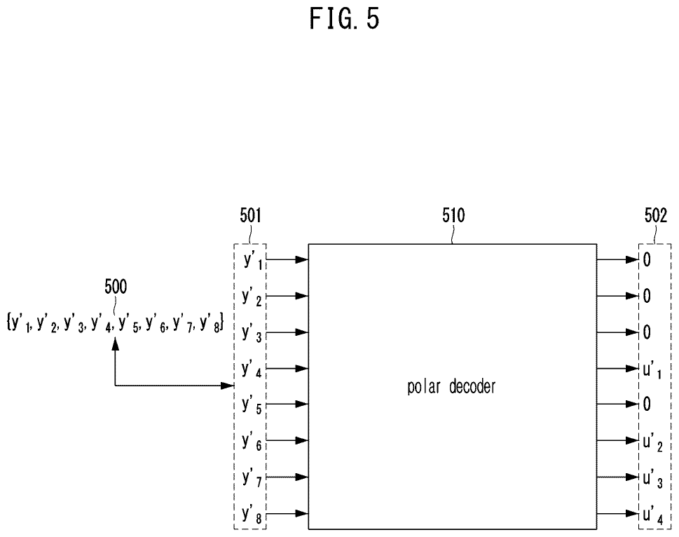

FIG. 5 is a conceptual diagram illustrating input and output of a polar decoder.

Referring to FIG. 5, received symbols 500 at a receiving node over a wireless channel may be a modified form of the encoded output {y₁, y₂, y₃, y₄, y₅, y₆, y₇, and y₈} of the transmitting node, as a result of interference and noise during transmission over the wireless channel.

Accordingly, the symbols 500 received at the receiving node may be expressed as {y′₁, y′₂, y′₃, y′₄, y′₅, y′₆, y′₇, y′₈}. The symbols 500 received at the receiving node, {y′₁, y′₂, y′₃, y′₄, y′₅, y′₆, y′₇, y′₈}, may be sequentially input to the input ports of a polar decoder 510 in order. It may be assumed that the input ports of the polar decoder 510 in FIG. 5 are indexed from top to bottom, ranging from an input port index 1 to an input port index 8, and that output ports of the polar decoder 510 are also indexed from top to bottom, ranging from an output port index 1 to an output port index 8.

According to the above assumption, y′₁ may be input to the input port at index 1, y′₂ may be input to the input port at index 2, and y′₈ may be input to the input port at index 8 in this manner. Furthermore, the output ports at indexes 1 to 3 of the polar decoder 510 may output already known frozen bits, and the output port at index 4 may output u′₁ decoded by the polar decoder 510. Additionally, the output port at index 5 of the polar decoder 510 may output a frozen bit, the output port at index 6 of the polar decoder 510 may output u′₂ decoded by the polar decoder 510, the output port at index 7 of the polar decoder 510 may output u′₃ decoded by the polar decoder 510, and the output port at index 8 of the polar decoder 510 may output u′₄ decoded by the polar decoder 510.

The polar decoder 510 may perform decoding by utilizing a relationship between the encoded bits {y₁, y₂, y₃, y₄, y₅, y₆, y₇, y₈} and values and positions of the frozen bits and the four information bits {u′₁, u′₂, u′₃, u′₄}. In other words, the polar decoder 510 may calculate the four information bits {u′₁, u′₂, u′₃, u′₄} from the received symbols 500, which are transmitted through the wireless channel, by solving the eight equations expressed by the XOR operations of the information bits.

As described in FIGS. 3A to 3C, the present disclosure relates to a wireless communication system that utilizes multiple TRPs. In the present disclosure described below, a method and an apparatus are provided for increasing channel coding gain and enhancing communication reliability using polar codes for a case where multiple TRPs intend to transmit information bits.

In the present disclosure described below, a polar code encoding method and a polar code decoding method are provided to increase channel coding gain in multi-TRP/panel communication, which aims to overcome data signal errors caused by significant electromagnetic wave loss and wireless channel blockage. A transmitting node according to the present disclosure may perform encoding by mapping the same input information bits to different positions for each TRP and/or each panel. Through this, as the number of TRPs/panels increases, a coding rate of channel coding may be reduced.

A receiving node according to the present disclosure may perform decoding for each TRP and/or each panel and recover a signal by combining decoded signals from the respective TRPs when a CRC error occurs in all TRPs/panels.

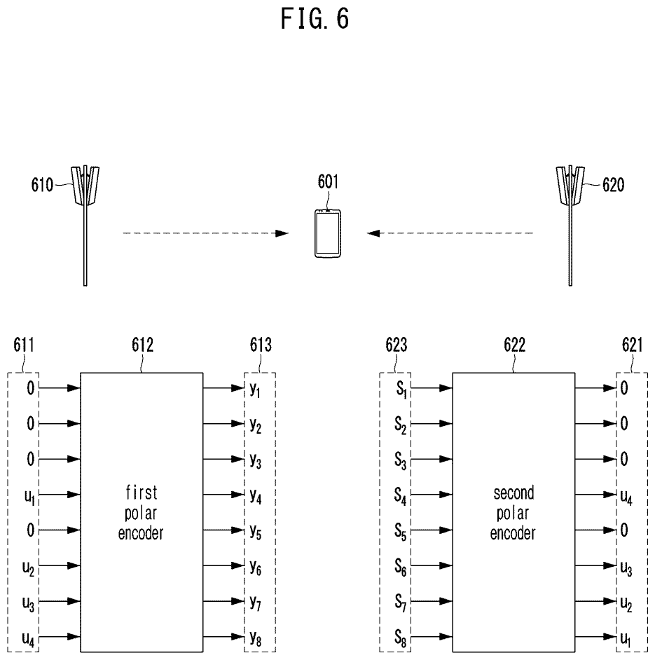

FIG. 6 is a conceptual diagram illustrating a case where each of two TRPs transmits information to a single UE using a polar encoder.

Referring to FIG. 6, a first TRP 610 may transmit information, such as control channel information of a mobile communication system, to a UE 601, and a second TRP 620 may transmit information, such as control channel information of the mobile communication system, to the UE 601. Here, the first TRP 610 and the second TRP 620 may be understood as different panels. In the following description, unless otherwise specifically noted, TRPs and panels may be used interchangeably. Therefore, it should be noted that, for convenience of description, only the term ‘TRPs’ is used in the following description.

At the bottom of the first TRP 610 in FIG. 6, a first polar encoder 612 included in the first TRP 610 is illustrated, and at the bottom of the second TRP 620, a second polar encoder 622 included in the second TRP 620 is illustrated. Input data 611 of the first TRP 610 may be encoded into a polar code by the first polar encoder 612, and encoded symbols 613 may be output by the first polar encoder 612. Additionally, input data 621 of the second TRP 620 may be encoded into a polar code by the second polar encoder 622, and encoded symbols 623 may be output by the second polar encoder 622. In the example of FIG. 6, the first polar encoder 612 and the second polar encoder 622 may have the same number of input bits and output bits.

When the number of information bits input to each of the first polar encoder 612 and the second polar encoder 622 is K, and the length of output bits of each of the first polar encoder 612 and the second polar encoder 622 is N, the number of frozen bits may be N-K. The positions of the frozen bits may be determined based on mutual information values. For example, positions of (N-K) frozen bits may be determined as positions having mutual information values smaller than mutual information values of K information bits. In other words, the positions of (N-K) frozen bits may be determined in ascending order starting from a position with the smallest mutual information value. Here, mutual information values may be calculated for the positions of input information bits in the polar encoder by modeling the wireless communication channel as a binary erasure channel or a binary symmetric channel.

The positions of frozen bits may be preconfigured in each of the polar encoders 611 and 622 or may be configured by a base station (not shown in FIG. 6) that controls the TRPs and/or panels. When the base station transmits information to the UE 601 using M TRPs/panels, the positions of the frozen bits for the polar encoders of all TRPs/panels may be configured to be identical. Additionally, as described above, the frozen bits in the present disclosure may be set to zero (0). When the frozen bits have a value of 0, (N-K) frozen bits configured for the polar encoders included in the M TRPs/panels may be input at the positions determined by the base station. In other words, the positions of the frozen bits for the polar encoders included in different TRPs may be fixed positions.

In the present disclosure, K information bits input to each polar encoder may be mapped (or input) to different positions for each polar encoder. For example, as illustrated in FIG. 6, when the two TRPs 610 and 620 transmit information bits to a single UE 601, input ports (or input mappings) of the information bits input to the first polar encoder 612 may be different from input ports (or input mappings) of the information bits input to the second polar encoder 622.

For example, the K information bits input to the first polar encoder 612 of the first TRP 610 may be input (or mapped) in ascending order of mutual information values, from the smallest to the largest value. On the other hand, the K information bits input to the second polar encoder 622 of the second TRP 620 may be input (or mapped) in descending order of mutual information values, from the largest to the smallest value.

Referring to the example illustrated in FIG. 6, operations described above may be performed as follows.

The base station may transmit the same information bits to the UE 601 via the first TRP 610 and the second TRP 620. Since the information bits transmitted by the base station to the UE 601 are identical, the polar encoders 612 and 622 included in the first TRP 610 and the second TRP 620, respectively, may have the same size.

The base station may provide, to the first TRP 610, information on the positions of frozen bits of the first polar encoder 612 included in the first TRP 610. Additionally, the base station may provide, to the second TRP 620, information on the positions of the frozen bits of the second polar encoder 622 included in the second TRP 620. In this case, the positions of the frozen bits of the first polar encoder 612 and the positions of the frozen bits of the second polar encoder 622, which are indicated by the base station, may be the same. As described above, the positions of the frozen bits in the first polar encoder 612 and the second polar encoder 622 may be determined by sequentially selecting N-K positions in ascending order of mutual information values.

The first polar encoder 612 and the second polar encoder 622 may be configured to input frozen bits at the frozen bit positions indicated by the base station. In other words, the frozen bit positions of the first polar encoder 612 and the second polar encoder 622 may have been predetermined.

Subsequently, the base station may transmit information on input positions of the information bits of the first polar encoder 612 or a mapping rule of the information bits thereof to the first TRP 610. In this case, the rule for mapping the information bits in the first polar encoder 612 may be to input (or map) the information bits in ascending order of mutual information values, from the smallest to the largest value, as described above. Additionally, the base station may transmit information on input positions of the information bits of the second polar encoder 622 or a mapping rule of the information bits thereof to the second TRP 620. In this case, the rule for mapping the information bits in the second polar encoder 622 may be to input (or map) the information bits in descending order of mutual information values, from the largest to the smallest value, as described above. In other words, the mapping rule for the information bits in the first polar encoder 612 may be different from the mapping rule for the information bits in the second polar encoder 622. Additionally, as described above, since the base station transmits the same information bits to the UE 601, the number of information bits to be transmitted may also be identical.

Each of the polar encoders 612 and 622 may output polar-encoded symbols by taking the frozen bits and information bits as inputs. As described above, the positions of the frozen bits may be determined based on mutual information values. In other words, the frozen bits may be sequentially arranged in (N-K) positions starting from the lowest input position among the input positions.

In the exemplary embodiment of FIG. 6, it may be assumed that the input ports of the polar encoder 610 are indexed from top to bottom, ranging from an input port index 1 to an input port index 8, and that output ports of the polar encoder 610 are also indexed from top to bottom, ranging from an output port index 1 to an output port index 8.

In this case, the input 611 of the first polar encoder 612 may consist of the frozen bits and information bits, and in the order of the input port index 1 to input port index 8, {0, 0, 0, u₁, 0, u₂, u₃, u₄} may be input. The input port indexes 1 to 3 and input port index 5, to which the frozen bits 0 are mapped, may correspond to input ports having lower mutual information values than the input port indexes to which the information bits are mapped. For example, the mutual information values for the input ports of the first polar encoder 612 based on channel modeling may be {0.0039, 0.1211, 0.1914, 0.6836, 0.3164, 0.8086, 0.8789, 0.9961} in the order of the input port index 1 to input port index 8.

Additionally, the output 613 of the first polar encoder 612 may output {y₁, y₂, y₃, y₄, y₅, y₆, y₇, y₈} in the order of the output port index 1 to output port index 8. In this case, the first polar encoder 612 may have the same configuration as that illustrated in FIG. 4B.

In the exemplary embodiment of FIG. 6, it may be assumed that the input ports of the second polar encoder 620 are indexed from top to bottom, ranging from an input port index 1 to an input port index 8, and that output ports of the polar encoder 620 are also indexed from top to bottom, ranging from an output port index 1 to an output port index 8.

In this case, the input 621 of the second polar encoder 622 may consist of the frozen bits and information bits, and in the order of input port index 1 to input port index 8, {0, 0, 0, u₄, 0, u₃, u₂, u₁} may be input. The frozen bits in the input 621 of the second polar encoder 622 may be located at the same positions as the frozen bits in the first polar encoder 612, while the information bits in the input 621 of the second polar encoder 622 may be located at different positions from the information bits in the first polar encoder 612. Additionally, as described for the first polar encoder 612, the mutual information values for the input ports of the second polar encoder 622 may be {0.0039, 0.1211, 0.1914, 0.6836, 0.3164, 0.8086, 0.8789, 0.9961}.

Additionally, the output 623 of the second polar encoder 622 may be {s₁, s₂, s₃, s₄, s₅, s₆, s₇, s₈} in the order of output port index 1 to output port index 8. In this case, the second polar encoder 622 may have the same configuration as that illustrated in FIG. 4B. When the second polar encoder 622 has the same configuration as FIG. 4B, the output 623 generated by the second polar encoder 622 may be expressed as in Equation 3 below.

$${s}_{1} = {u}_{4} ⊕ {u}_{3} ⊕ {u}_{2} ⊕ {u}_{1} \qquad [ Equation 3 ]$$

$${s}_{2} = {u}_{4} ⊕ {u}_{3} ⊕ {u}_{1}$$

$${s}_{3} = {u}_{4} ⊕ {u}_{2} ⊕ {u}_{1}$$

$${s}_{4} = {u}_{4} ⊕ {u}_{1}$$

$${s}_{5} = {u}_{3} ⊕ {u}_{2} ⊕ {u}_{1}$$

$${s}_{6} = {u}_{3} ⊕ {u}_{1}$$

$${s}_{7} = {u}_{2} ⊕ {u}_{1}$$

$${s}_{8} = {u}_{1}$$

Comparing Equation 2 and Equation 3, it can be seen that there exist outputs with the same mapping relationships and outputs with different mapping relationships. For example, y₁ and s₁, y₂ and s₃, y₃ and s₂, and y₄ and s₄ have the same mapping relationships. In contrast, the outputs y₅, y₆, y₇, and y₈ of the first polar encoder 612 and the outputs s₅, s₆, s₇, and s₈ of the second polar encoder 622 have different mapping relationships. As the number of outputs with different mapping relationships between the outputs of the polar encoders increases, a channel coding rate decreases, and a channel coding gain may increase.

The above description provides the method for determining input bits of a polar encoder when M is 2, that is, when there are two different TRPs or two different panels. However, when M is greater than 2, a different method may be required for mapping input information bits to the polar encoder. Hereinafter, a method of mapping input information bits to polar encoders as M varies will be described.

### (1) When M is 2

When M is 2, input information mapping for the polar encoders included in the first TRP and the second TRP may be performed in the same manner as described above. In other words, the input information mapping method for the first polar encoder of the first TRP and the input information mapping method for the second polar encoder of the second TRP may be used.

(2) when M is Greater than 2 and Less than or Equal to 4

When M is less than or equal to 4, the input information mapping for the polar encoders included in the first TRP and the second TRP may be performed in the same manner as described above. In other words, the input information mapping method for the first polar encoder of the first TRP and the input information mapping method for the second polar encoder of the second TRP may be used.

The input information mapping for the third polar encoder included in the third TRP may be performed by circularly shifting the input information bits of the first polar encoder of the first TRP by [K/2]. Additionally, the input information mapping for the fourth polar encoder included in the fourth TRP may be performed by circularly shifting the input information bits of the second polar encoder of the second TRP by [K/2].

(3) When M is Greater than 4 and Less than or Equal to 8

The input information mapping of the encoders included in the first TRP and the second TRP may be performed in the same manner as described above. In other words, the input information mapping method for the first polar encoder of the first TRP and the input information mapping method for the second polar encoder of the second TRP may be used.

The input information mapping for the third polar encoder included in the third TRP may be performed by circularly shifting the input information bits of the first polar encoder of the first TRP by [K/4]. Additionally, the input information mapping for the fourth polar encoder included in the fourth TRP may be performed by circularly shifting the input information bits of the second polar encoder of the second TRP by [K/4].

Furthermore, the input information mapping for the fifth polar encoder included in the fifth TRP may be performed by circularly shifting the input information bits of the third polar encoder of the third TRP by [K/4]. Additionally, the input information mapping for the sixth polar encoder included in the sixth TRP may be performed by circularly shifting the input information bits of the fourth polar encoder of the fourth TRP by [K/4].

Moreover, the input information mapping for the seventh polar encoder included in the seventh TRP may be performed by circularly shifting the input information bits of the fifth polar encoder of the fifth TRP by [K/4]. Additionally, the input information mapping for the eighth polar encoder included in the eighth TRP may be performed by circularly shifting the input information bits of the sixth polar encoder of the sixth TRP by [K/4].

(4) When M is Greater than 8 and Less than or Equal to 16

The input information mapping of the encoders included in the first TRP and the second TRP may be performed in the same manner as described above. In other words, the input information mapping method for the first polar encoder of the first TRP and the input information mapping method for the second polar encoder of the second TRP may be used.

The input information mapping for the third polar encoder included in the third TRP may be performed by circularly shifting the input information bits of the first polar encoder of the first TRP by [K/8]. Additionally, the input information mapping for the fourth polar encoder included in the fourth TRP may be performed by circularly shifting the input information bits of the second polar encoder of the second TRP by [K/8].

The input information mapping for the fifth polar encoder included in the fifth TRP may be performed by circularly shifting the input information bits of the third polar encoder of the third TRP by [K/16]. Additionally, the input information mapping for the sixth polar encoder included in the sixth TRP may be performed by circularly shifting the input information bits of the fourth polar encoder of the fourth TRP by [K/8].

The input information mapping for the seventh polar encoder included in the seventh TRP may be performed by circularly shifting the input information bits of the fifth polar encoder of the fifth TRP by [K/16]. Additionally, the input information mapping for the eighth polar encoder included in the eighth TRP may be performed by circularly shifting the input information bits of the sixth polar encoder of the sixth TRP by [K/8].

The input information mapping for the ninth polar encoder included in the ninth TRP may be performed by circularly shifting the input information bits of the seventh polar encoder of the seventh TRP by [K/16]. Additionally, the input information mapping for the tenth polar encoder included in the tenth TRP may be performed by circularly shifting the input information bits of the eighth polar encoder of the eighth TRP by [K/8].

The input information mapping for the eleventh polar encoder included in the eleventh TRP may be performed by circularly shifting the input information bits of the ninth polar encoder of the ninth TRP by [K/16]. Additionally, the input information mapping for the twelfth polar encoder included in the twelfth TRP may be performed by circularly shifting the input information bits of the tenth polar encoder of the tenth TRP by [K/8].

The input information mapping for the thirteenth polar encoder included in the thirteenth TRP may be performed by circularly shifting the input information bits of the eleventh polar encoder of the eleventh TRP by [K/8]. Additionally, the input information mapping for the fourteenth polar encoder included in the fourteenth TRP may be performed by circularly shifting the input information bits of the twelfth polar encoder of the twelfth TRP by [K/8].

The input information mapping for the fifteenth polar encoder included in the fifteenth TRP may be performed by circularly shifting the input information bits of the thirteenth polar encoder of the thirteenth TRP by [K/8]. Additionally, the input information mapping for the sixteenth polar encoder included in the sixteenth TRP may be performed by circularly shifting the input information bits of the fourteenth polar encoder of the fourteenth TRP by [K/8].

When M is greater than 16, the input information bits corresponding to each TRP may be mapped by circularly shifting in the same manner as described in the example of (3) above.

Accordingly, the base station may provide information on each TRP to the UE in advance so that the UE can recognize the mapping order of the information bits for each TRP. Various methods may be used for providing such information.

### [A] Method 1 for a Base Station to Provide TRP Information to a UE

The base station may provide information on TRPs available for use in advance through a radio resource control (RRC) message via a specific TRP or multiple TRPs. Here, the RRC message may be either an RRC configuration message or an RRC reconfiguration message.

Subsequently, the base station may provide a UE with a set of TRPs to be used for data transmission and an information bit mapping scheme of the polar encoder for each TRP within the set through a MAC control element (MAC-CE). Here, data may be DCI transmitted through a PDCCH. Additionally, the information bit mapping scheme of the polar encoder for each TRP may follow any of the methods described in (1) to (4) above, depending on the number of TRPs.

### [B] Method 2 for a Base Station to Provide TRP Information to a UE

The base station may provide information on TRPs available for use in advance through an RRC message via a specific TRP or multiple TRPs. Here, the RRC message may be either an RRC configuration message or an RRC reconfiguration message. In this case, the RRC message may include TRP information for identifying each TRP. Additionally, the RRC message may specify the information bit mapping scheme of the polar encoder according to the number of TRPs used for data transmission. The information bit mapping scheme of the polar encoder according to the number of TRPs may follow any of the methods described in (1) to (4) above.

Subsequently, the base station may transmit information on TRPs to be used for data transmission and information on the order of the TRPs to the UE through a MAC-CE. Here, data may be DCI transmitted through a PDCCH.

When the same information bits are polar-encoded in the same order for each of the M TRPs, all encoded symbols output by the TRPs are identical. Therefore, from a receiving node perspective, the respective TRPs may be understood as different antennas. In other words, when all TRPs perform polar encoding on the same information bits in the same input bit order, the receiving node may obtain only a diversity gain from the wireless channel. Here, the diversity gain may refer to an increase in a probability of successfully recovering the signal at the receiving node because a probability that all signals transmitted from the TRPs experience errors simultaneously is reduced. This method takes advantage of a fact that the respective signals transmitted by the TRPs experience different wireless channels, reducing the probability that all signals are affected by errors.

However, as described in the present disclosure, when each TRP performs polar encoding such that different TRPs have different output values, some of the encoded symbols output by the TRPs remain identical, while the remaining symbols have different values. Consequently, the receiving node may obtain both diversity gain and channel coding gain. Here, the channel coding gain may refer to a reduction in a probability of an error occurring in a received bit due to the receiving node receiving additional information on the given bit.

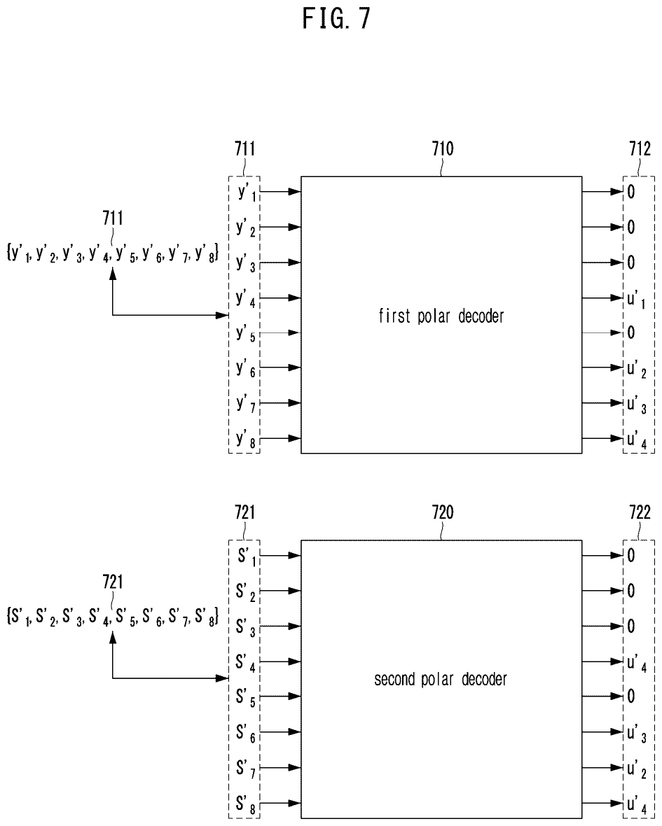

FIG. 7 is a conceptual diagram illustrating a decoding operation of a polar decoder in a UE receiving information from two TRPs.

Referring to FIG. 7, polar decoders 710 and 720, each having an 8-bit input are illustrated. Input data 711 and 721 received from different TRPs may be input to the polar decoders 710 and 720, respectively.

First, the data 711 input to the first polar decoder 710 may be symbols received from the TRP illustrated in FIG. 5 or the first TRP illustrated in FIG. 6. In other words, the encoded output {y₁, y₂, y₃, y₄, y₅, y₆, y₇, y₈} from the first TRP, which has undergone interference and noise while traversing the wireless channel, may be received as symbols {y′₁, y′₂, y′₃, y′₄, y′₅, y′₆, y′₇, y′₈}. Accordingly, the symbols {y′₁, y′₂, y′₃, y′₄, y′₅, y′₆, y′₇, y′₈} received from the first TRP may be sequentially input to the respective input ports of the first polar decoder 710. A method of inputting the received symbols {y′₁, y′₂, y′₃, y′₄, y′₅, y′₆, y′₇, y′₈} into the respective input ports of the first polar decoder 710 may follow the same method as described in FIG. 5. The first polar decoder 710 may decode the received symbols {y′₁, y′₂, y′₃, y′₄, y′₅, y′₆, y′₇, y′₈} and output decoded symbols 712 as {0, 0, 0, u′₁, 0, u′₂, u′₃, u′₄}.

The decoded symbols 712 output from the first polar decoder 710 may be verified for decoding success using CRC bits. In other words, the UE may determine whether the decoding of the symbols 712 is successful or unsuccessful using CRC bits.

Next, the data 721 input to the second polar decoder 720 may be symbols polar-encoded by the second polar encoder 622 and received through the wireless channel, as described in FIG. 6. The symbols {s₁, s₂, s₃, s₄, s₅, s₆, s₇, s₈}, polar-encoded by the second polar encoder 622, may be delivered to the receiving node in a distorted state due to interference and noise while traversing the wireless channel. Accordingly, the received symbols 721 input to the second polar decoder 720 may be represented as {s′₁, s′₂, s′₃, s′₄, s′₅, s′₆, s′₇, s′₈}. Accordingly, the symbols 721 received from the second TRP may then be sequentially input to the input ports of the second polar decoder 720. A method of inputting the received symbols {s′₁, s′₂, s′₃, s′₄, s′₅, s′₆, s′₇, s′₈} to the input ports of the second polar decoder 720 may follow the same method as described in FIG. 5. The second polar decoder 720 may decode the received symbols 721 and output the decoded symbols 722 as {0, 0, 0, u″₄, 0, u″₃, u″₂, u″₁}.

The decoded symbols 722 output from the second polar decoder 720 may be verified for decoding success using CRC bits. In other words, the UE may determine whether the decoding of the symbols 722 is successful or unsuccessful using CRC bits.

Meanwhile, both the first TRP and the second TRP may transmit the same data. Therefore, the UE may combine information bits received from different TRPs to redetermine the information bits. The UE may also verify decoding success or failure of the determined information bits using CRC bits.

If decoding of the signals received from both the first TRP and the second TRP fails, the UE may estimate information bit values by performing soft combining of log-likelihood ratio (LLR) values corresponding to the information bit positions from the first polar decoder 710 and the second polar decoder 720. For example, the information bits from the decoded output of the first polar decoder 710, as illustrated in FIG. 7, may be {u′₁, u′₂, u′₃, u′₁}. Additionally, the information bits from the decoded output of the second polar decoder 720 may be {u″₄, u″₃, u″₂′, u″₁}. Accordingly, the UE may perform soft combining of the same information bits corresponding to each other, such as combining u′₁ with u″₂, combining u′₂ with u″₂, combining u′₃ with u″₃, and combining u′₄ with u″₄, to estimate u₁, u₂, u₃, and u₄, respectively. In this case, a decision method may involve using a result of the soft combining, where the UE determines the corresponding information bit based on whether the combined LLR value is greater than or less than 0. Thus, the UE may decide the information bits based on the soft combining results.

Alternatively, when performing the soft combining, the UE may reflect signal-to-noise ratio (SNR) or signal-to-interference-plus-noise ratio (SINR) values measured during signal reception and apply a maximum ratio combining (MRC) method to estimate u₁, u₂, u₃, and u₄, respectively. Consequently, the UE may decide the information bits based on the results of maximum ratio combining. The UE may use CRC bits included in the re-estimated information bits based on the soft combining or maximum ratio combining method to verify decoding success or failure again.

In the present disclosure described above, a polar code may also be used for a PDSCH when handling short-length data. When a polar code is used for short-length PDSCH data, the base station may instruct the UE to use the polar code. The UE may be instructed to use the polar code based on DCI transmitted through a PDCCH, or may be preconfigured to use the polar code based on an RRC message.

When the base station uses a polar code for a PDSCH, the UE may provide feedback to the base station regarding a decoding success result determined based on CRC bits after performing polar decoding. In this case, the decoding success result may be either an acknowledgement (ACK) or a negative acknowledgment (NACK).

The above exemplary embodiment describes a case where M is 2. However, when M is greater than 2, that is, as in cases (2) to (4) described above, the number of TRPs transmitting the same information to a single UE may be large. In such cases, if polar decoding fails for all signals received from the TRPs, the UE may re-estimate the information bits using soft combining or maximum ratio combining, as described above. If the additional estimation is performed and a CRC check result still indicates a decoding failure, the UE may transmit a NACK to the base station. In other words, when decoding fails for all signals received from M TRPs, and even after re-estimating the information using soft combining or maximum ratio combining, the CRC check result indicates a decoding failure, the UE may transmit a NACK to the base station. Conversely, if decoding succeeds for at least one of the signals received from M TRPs, or if decoding fails for all received signals but information is successfully re-estimated using soft combining or maximum ratio combining and verified using CRC bits, the UE may transmit an ACK to the base station.

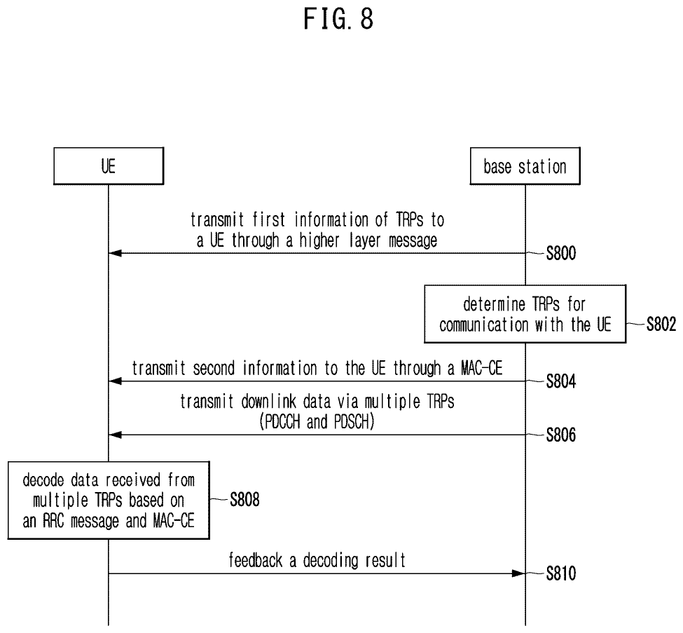

FIG. 8 is a sequence chart illustrating a case where a base station transmits data to a UE using polar encoders in multiple TRPs.

Referring to FIG. 8, a base station and a UE are illustrated. The base station may include two or more TRPs connected to the base station. Here, the TRPs may also be understood as panels of the base station. It should be noted that, for convenience of description, TRPs are omitted in FIG. 8. Additionally, the sequence chart in FIG. 8 only illustrates a procedure in which the base station transmits data to the UE using polar encoders included in multiple TRPs. Therefore, it should be noted that other procedures are not considered.

In step S800, the base station may provide first information to the UE through a higher layer message. The first information may include information on each of all TRPs connected to the base station. The first information may also include TRP identification information for identifying each TRP connected to the base station. Furthermore, the first information may include information on TRP set(s) that the base station is to use for communication with the UE. The information on TRP set(s) may include one or more TRPs. For example, a single TRP set may include identification information for two TRPs. If a first TRP set includes identification information for two TRPs, the first TRP set may consist of two TRPs as its elements. A second TRP set may include identification information for four TRPs. If the second TRP set includes identification information for four TRPs, the second TRP set may consist of four TRPs as its elements. A third TRP set may include identification information only for one TRP. If the third TRP set includes only one TRP, the third TRP set may consist of a single TRP as its element. Additionally, a TRP may be included in multiple TRP sets. For example, a first TRP may be included in the first TRP set, the second TRP set, and the third TRP set.

Furthermore, the first information may include input data mapping information for the polar encoder. The input data mapping information for the polar encoder may include frozen bit position information. The input data mapping information for the polar encoder may be information for inputting information bits to the polar encoder included in each TRP, as described in (1) to (4) above. The higher layer message may be an RRC configuration message or an RRC reconfiguration message.

In step S800, the base station may transmit the higher layer message to the UE via a single TRP, or the base station may directly transmit the higher layer message to the UE. Accordingly, in step S800, the UE may receive the higher layer message either directly from the base station or via a TRP.

In step S802, the base station may determine TRPs for communication with the UE. When determining the TRPs for communication with the UE, the base station may determine the TRPs based on various information measured by the UE and reported to the base station. It should be noted that in the exemplary embodiment of FIG. 8, an operation in which the UE reports measurement information is not illustrated.

In step S804, the base station may transmit second information to the UE via the determined TRPs or one of the determined TRPs. The second information may be transmitted to the UE through a MAC-CE. The second information may include information on a TRP set for communication with the UE. The second information may also include information on an order of TRPs included in the TRP set for communication with the UE. This is necessary because, as described in (1) to (4) above, the positions of the information bits input to the polar encoder varies depending on the value of M, and thus the UE needs to identify such information.

Meanwhile, FIG. 8 only illustrates the information and data exchanged between the base station and the UE. However, when the base station transmits data to the UE via multiple TRPs, at least part of the second information may be transmitted to each TRP. For example, in step S800, each TRP may receive input data mapping information for the polar encoder from the base station, which is a part of the first information provided to the UE. Additionally, in step S804, each TRP may receive information on the order from the base station, which is a part of the second information provided to the UE. Through this, each TRP may determine the input information mapping position for the polar encoder included in each TRP.

In step S804, the base station may transmit a MAC-CE to the UE either directly or via a single TRP. Accordingly, in step S804, the UE may receive the MAC-CE either directly from the base station or via a single TRP. The base station may also transmit the MAC-CE to the UE via multiple TRPs in step S804. In such cases, the UE may receive the MAC-CE via multiple TRPs in step S804.

In step S806, the base station may transmit PDCCH(s) and/or PDSCH(s) via multiple TRPs for communication with the UE. Accordingly, each of the multiple TRPs may encode data using a polar encoder based on the method described above, either encoding only the PDCCH or encoding both the PDCCH and PDSCH. At this time, each of the multiple TRPs may encode the data received from the base station, i.e., the data to be transmitted to the UE, using a polar encoder based on a scheme preconfigured by the base station. In this case, input positions of information bits (data to be transmitted to the UE) in each of the multiple TRPs may be preconfigured by the base station. The input positions of the information bits may be determined based on the methods described in (1) to (4) above. The data encoded by each of the multiple TRPs may then be transmitted to the UE. Here, the data transmitted by the multiple TRPs may be identical. Accordingly, the input order of the information bits in the polar encoders of the TRPs may be determined by the base station.

In step S806, the UE may receive signals from the multiple TRPs.

In step S808, the UE may decode the received signals from the multiple TRPs based on the RRC message received in step S800 and the MAC-CE received in step S804. As described in FIG. 7, the UE may determine decoding success or failure based on whether any of the received signals from the multiple TRPs are successfully decoded using CRC bits.

If decoding fails for all received signals from the multiple TRPs, the UE may re-estimate the information bits using soft combining or maximum ratio combining. The UE may then determine decoding success or failure based on CRC verification of the re-estimated information bits. If the decoding fails after verifying the CRC of the re-estimated bits, the UE may generate NACK information, and if decoding succeeds, the UE may generate ACK information.

In step S810, the UE may transmit the decoding result, ACK or NACK, to the base station. At this time, the ACK or NACK may be transmitted to all TRPs or to a specific TRP.

Subsequently, if the base station receives a NACK, it may retransmit the same data using all TRPs. This retransmission procedure is not illustrated in FIG. 8.

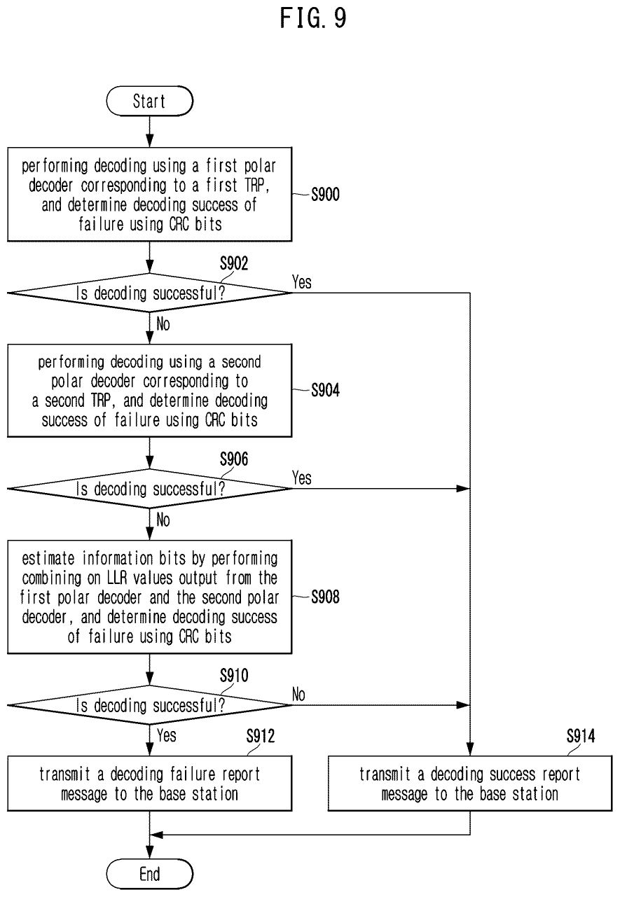

FIG. 9 is a flowchart illustrating a process in which a UE decodes signals received from multiple TRPs using polar decoders.

The flowchart in FIG. 9 illustrates a case where signals are received from two TRPs. However, if three or more TRPs are used for data transmission to a single UE, the flowchart of FIG. 9 may be extended accordingly.

In step S900, the UE may perform decoding using a first polar decoder corresponding to the first TRP. After decoding using the first polar decoder, the UE may determine decoding success or failure using CRC bits.

In step S902, if the UE determines that decoding is successful, the UE may proceed to step S914. If decoding fails, the UE may proceed to step S904.

In step S914, the UE may transmit a report message including ACK information, indicating decoding success, to the base station.

In step S904, the UE may perform decoding using the second polar decoder corresponding to the second TRP. After decoding using the second polar decoder, the UE may determine decoding success or failure using CRC bits.

In step S906, if the UE determines that decoding is successful, the UE may proceed to step S914. If decoding fails, the UE may proceed to step S908.

In step S908, the UE may estimate information bits by performing soft combining or maximum ratio combining on LLR output values corresponding to information bits of the first polar decoder and the second polar decoder. The UE may determine decoding success or failure using CRC bits based on the estimated information bits. If decoding results from individual TRPs indicate failure, the UE may re-estimate the information bits using soft combining or maximum ratio combining. The UE may then determine decoding success or failure again using CRC bits on the re-estimated information bits.

In step S910, if the UE determines that decoding is successful based on the CRC check of the re-estimated information bits, the UE may proceed to step S914. If decoding fails, the UE may proceed to step S912.

In step S912, the UE may transmit a report message including NACK information, indicating decoding failure, to the base station.

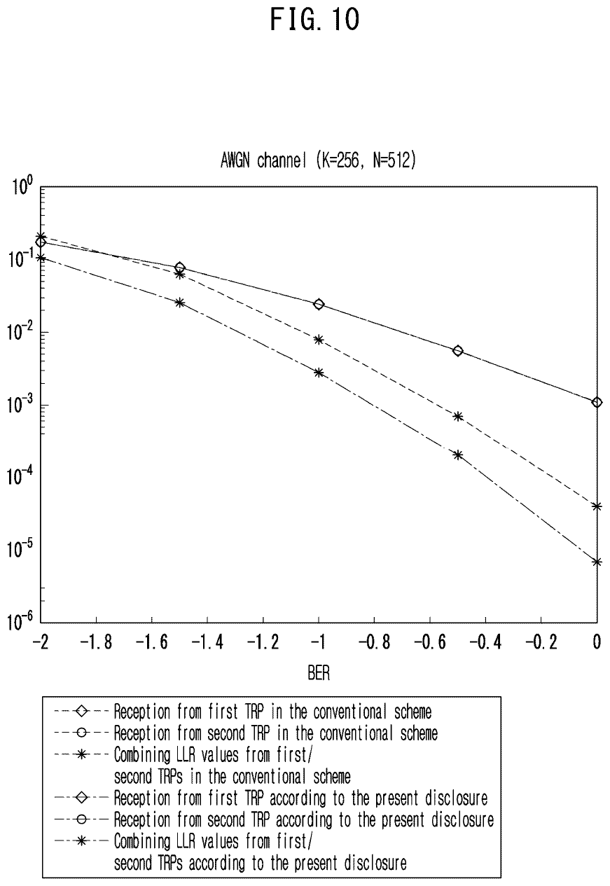

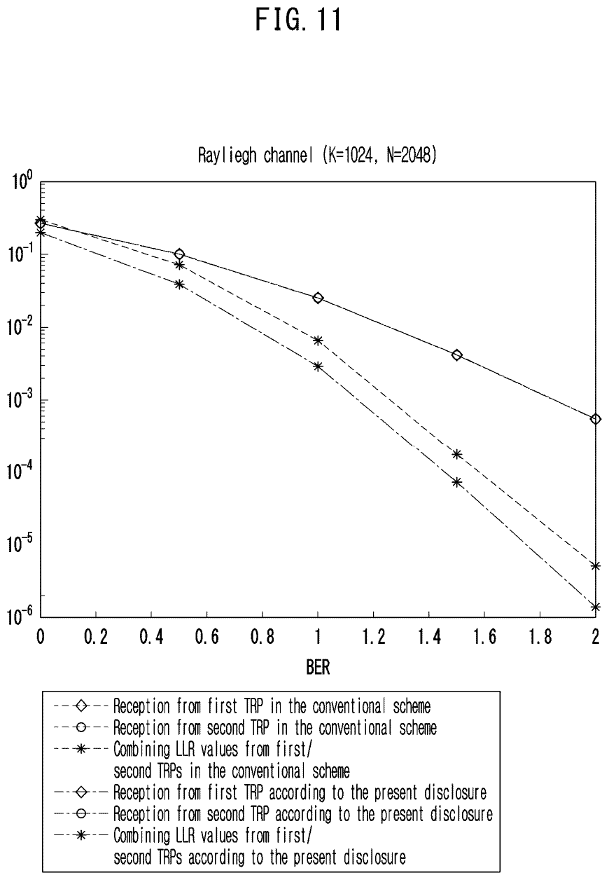

FIG. 10 is a simulation graph comparing performance of the present disclosure and conventional techniques in an AWGN channel, and FIG. 11 is a simulation graph comparing performance of the present disclosure and conventional techniques in a Rayleigh channel.

In FIG. 10 and FIG. 11, the first TRP and the second TRP may both transmit the same data. Additionally, in the case of conventional techniques, the polar encoders of the first TRP and the second TRP may perform encoding on data using the same information bit positions.

On the other hand, in the case of the present disclosure, the simulation graph represents results where the polar encoders of the first TRP and the second TRP perform encoding on data using different information bit positions, as described above. The performance difference between the signals received from the first TRP and the second TRP in the encoding method of conventional techniques and the encoding method described in the present disclosure is minimal. However, when CRC check results at the first TRP and the second TRP indicate errors, and LLR values are combined, the polar encoders described in the present disclosure demonstrate superior performance compared to the conventional polar encoders.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving, from a base station, a first message including information of transmission and reception point (TRP) sets each composed of TRPs and input data mapping information;
receiving, from the base station, a second message including information on a first TRP set to be used for communication among the TRP sets and information on an order of TRPs included in the first TRP set;
receiving signals from the TRPs included in the first TRP set; and
decoding each of the signals received from the TRPs included in the first TRP set using a polar decoder based on the input data mapping information.

2. The method according to claim 1, further comprising:
determining whether decoding is successful or not using cyclic redundancy check (CRC) bits for decoded symbols;
in response to determining that decoding of all signals received from the TRPs included in the first TRP set fails, combining information bits corresponding to each other among outputs of polar decoders of different TRPs, based on the input data mapping information;
determining information bits using the combined information bits;
determining whether decoding of the determined information bits is successful or not using the CRC bits; and
transmitting a decoding result report message to the base station.

3. The method according to claim 2, wherein the information bits corresponding to each other are combined using either a soft combining scheme or a maximum ratio combining scheme.

4. The method according to claim 1, wherein the input data mapping information indicates positions of frozen bits and input positions of information bits for a polar encoder of each of the TRPs included in the first TRP set.

5. The method according to claim 4, wherein the positions of the frozen bits are determined based on mutual information values.

6. The method according to claim 4, wherein the positions of the frozen bits are identical for all polar encoders included in the first TRP set.

7. The method according to claim 1, wherein the TRPs included in the first TRP set transmit same information bits, and input positions of information bits are different for polar encoders corresponding to the TRPs included in the first TRP set.

8. A method of a base station, comprising:
transmitting, to a user equipment (UE), a first message including information of transmission and reception point (TRP) sets each composed of TRPs and input data mapping information;
transmitting, to the UE, a second message including information on a first TRP set to be used for communication among the TRP sets and information on an order of TRPs included in the first TRP set;
instructing each of the TRPs included in the first TRP set to encode data based on the input data mapping information; and
transmitting the encoded data to the UE via the TRPs included in the first TRP set.

9. The method according to claim 8, wherein the input data mapping information indicates positions of frozen bits and input positions of information bits for a polar encoder of each of the TRPs included in the first TRP set.

10. The method according to claim 9, wherein the positions of the frozen bits are determined based on mutual information values.

11. The method according to claim 9, wherein input positions of information bits are different for polar encoders corresponding to the TRPs included in the first TRP set.

12. The method according to claim 9, wherein when the first TRP set includes two TRPs, input positions of the information bits for the two TRPs are determined such that:
the information bits are arranged at positions excluding the positions of the frozen bits among input ports of a first polar encoder of a first TRP, in order from a position with a smallest mutual information value to a position with a highest mutual information value, and
the information bits are arranged at positions excluding the positions of the frozen bits among input ports of a second polar encoder of a second TRP, in order from the position with the highest mutual information value to the position with the smallest mutual information value.

13. The method according to claim 9, wherein when the first TRP set includes four TRPs, input positions of the information bits for the four TRPs are determined such that:
the information bits are arranged at positions excluding the positions of the frozen bits among input ports of a first polar encoder of a first TRP in order from a position with a smallest mutual information value to a position with a highest mutual information value;
the information bits are arranged at positions excluding the positions of the frozen bits among input ports of a second polar encoder of a second TRP in order from the position with the highest mutual information value to the position with the smallest mutual information value;
the information bits are arranged at positions excluding the positions of the frozen bits among input ports of a third polar encoder of a third TRP by circularly shifting the information bits of the first polar encoder by [K/2]; and
the information bits are arranged at positions excluding the positions of the frozen bits among input ports of a fourth polar encoder of a fourth TRP by circularly shifting the information bits of the second polar encoder by [K/2].

14. The method according to claim 8, wherein data transmitted by the TRPs included in the first TRP set to the UE is same data.

15. A user equipment (UE) comprising at least one processor, wherein the at least one processor causes the UE to perform:
receiving, from a base station, a first message including information of transmission and reception point (TRP) sets each composed of TRPs and input data mapping information;
receiving, from the base station, a second message including information on a first TRP set to be used for communication among the TRP sets and information on an order of TRPs included in the first TRP set;
receiving signals from the TRPs included in the first TRP set; and
decoding each of the signals received from the TRPs included in the first TRP set using a polar decoder based on the input data mapping information.

16. The UE according to claim 15, wherein the at least one processor further causes the UE to perform:
determining whether decoding is successful or not using cyclic redundancy check (CRC) bits for decoded symbols;
in response to determining that decoding of all signals received from the TRPs included in the first TRP set fails, combining information bits corresponding to each other among outputs of polar decoders of different TRPs, based on the input data mapping information;
determining information bits using the combined information bits;
determining whether decoding of the determined information bits is successful or not using the CRC bits; and
transmitting a decoding result report message to the base station.

17. The UE according to claim 16, wherein the information bits corresponding to each other are combined using either a soft combining scheme or a maximum ratio combining scheme.

18. The UE according to claim 15, wherein the input data mapping information indicates positions of frozen bits and input positions of information bits for a polar encoder of each of the TRPs included in the first TRP set.

19. The UE according to claim 18, wherein the positions of the frozen bits are determined based on mutual information values.

20. The UE according to claim 15, wherein the TRPs included in the first TRP set transmit same information bits, and input positions of information bits are different for polar encoders corresponding to the TRPs included in the first TRP set.
